(19) United States
(12) Patent Application Publication
(10) Pub. No.: US 2003/0127773 A1
(43) Pub. Date: Jul. 10, 2003

(54) Procedure to create a tear seam in thin sheets and thinly shaped pieces

(76) Inventors: Ulf Feistel, Laasdorf (DE); Roland Diener, Weida (DE)

Correspondence Address: Mark D. Wieczorek, Ph.D., Esq., P.O. Box 70072, San Diego, CA, 92167, US

(21) Appl. No.: 10/317,440

(22) Filed: Dec. 12, 2002

(30) Foreign Application Priority Data
Dec. 18, 2001 (DE) 101 64 528.7

(51) Int. Cl. B29C 59/02

(52) U.S. Cl. 264/293

(57) ABSTRACT

Procedure to produce a tear seam in thin sheets and thinly shaped pieces that are manufactured using a thermal shaping procedure, in which the surface shape is firmly applied to at least one side of the thin film or thinly shaped piece (hereafter called the outer side) by application onto the surface of a mold, and that the material is in a liquid state for a certain time, and that the tear seam is formed during the plastic phase.

### CROSS REFERENCE TO RELATED APPLICATIONS

This application claims priority under 35 U.S.C. §119 to German Application Serial No. 101 64 528.7, entitled “Verfahren zum Einbringen einer Reiβnaht in Folien und dünne Formteile”, filed in the German Patent Office on Dec. 18, 2001.

### FIELD OF THE INVENTION

The invention relates to a procedure for creating a tear seam in thin sheets, particularly decorative sheets that are used as the top layer of dashboard coverings and other covered parts in automobile passenger compartments, and to create them so they alone are the covering.

### BACKGROUND OF THE INVENTION

Normally, these covering parts for automobiles are produced by combining firmly shaped base pieces and pre-formed sheets with a foam layer. The sheet serves as the visible surface layer. Covering parts are also known that consist of only one layer of material. In the meantime, airbags are not only installed behind these covering parts, in front of a vehicles occupants, but must in case of a collision be able to reliably break through these covering parts in a timely and spatially correct manner. To this end, defined intentional break points are included in the covering parts.

To include the intentional break points, procedures are known in which the intentional break points are included in the completed layered construction, and those in which a thin layer provided with a tear seam are already combined with the other layers.

To install a tear seam in a thin sheet or thinly shaped piece, mechanical procedures such as cutting, grinding, or perforating are known, as are procedures that create a cut or perforation by using lasers. Thereby, the tear seam is made to a depth which will not be visible from the passenger side, into the sheet or shaped part that faces away from the passenger compartment. Thus, the tear seam may be formed as a slit or a row of blind holes. The difficulty lies in that the thin sheet or thinly shaped piece must undergo a specific weakening so that it may be opened under a specific tearing force.

In order to provide a thin sheet or shaped piece with a tear seam, a process according to the state of the art for manufacturing thin sheets or thinly shaped pieces and a process for creating the tear seam are required. Thus processes from different technologies that require different machine facilities and at least one change of location of the thin sheet, including the possibility of intermediate storage are involved.

So-called spray and powder procedures are known for the manufacture of thin sheets and thinly shaped pieces (hereafter known as shaped parts).

In the powder process, the raw material is usually introduced into a heated shaping mold and the mold is shaken or rotated so that the raw material is distributed throughout the mold. When the raw material comes in contact with the mold surfaces, it melts and is joined to a shaped piece that conforms to the negative contour of the shaped piece surface.

Powder procedures are also known in which powder particles are electrostatically charged and then sprayed onto a grounded metallic mold. The melting process that forms the sheet is then performed by heating the metallic mold.

It is also known to warm the powder layers using infrared radiation, thus causing the melting.

In the injection process, the liquid material is sprayed in layers onto the mold, where it hardens after cooling.

All these described and other shaping procedures have in common the fact that the material is in a plastic state for a certain time, and the surface shape is determined by at least one side of the mold (hereafter, the outer side) by means of application on the surface of the mold.

### SUMMARY OF THE INVENTION

It is a task of the invention to describe a procedure in which a tear seam with a defined material weakness can be made during the manufacture process of the thin sheet or shaped piece.

This task is solved by a procedure to make a tear seam based on the overall concept of patent claim 1 in that the tear seam is formed in the material by means of a mold tool with at least one mold element during the plastic phase, whereby the mold tool is positioned at a defined distance from the surface of the mold and is removed again before the material hardens.

Essential to the invention is the fact that the mold tool is positioned at a defined distance from the mold surface which determines the shape of the shaped piece on one side, so that the distance between mold surface and the free ends of the mold elements located on the mold tool may be defined so as to be reproducible. Thus, a defined remaining wall thickness below the shaping caused by the mold elements is achieved, free of variation in the material thickness of the shaped piece. The tear seam includes a tearing behavior defined so as to be reproducible, independent of the variation in material thickness. Depending on the design of the mold elements, the shaping may be a slot of various cross-sections and lengths, or a series of varying positions of blind holes of varying cross-section, depth, and separation. Thus, the mold tool may have a cutter corresponding to the desired slit or an arrangement of tips. With equally-long tips and a smooth cutting edge, the formations on a smooth surface of the outer side of the shaped piece may provide a constant remaining wall thickness along the tear line. If the surface of the shaped piece is three-dimensional, the progression of the cutting edge or the lengths of the tips may be suitably adjusted so that constant remaining wall strength is provided along the entire length of the tear seam.

The intentional variation of separation and depth allows the creation, for example, of a tear line that begins to tear at a specific location because of the position ally-limited variation in material weakening within the tear line. For non-closed tear lines, which are always of interest when a complete release of the inner covering part is not desired, i.e., when a section of non-weakened material between the ends of the tear line serves as a hinge, the material may be increasingly weakened from the ends toward the center in order to cause tear formation beginning in the center and expanding to the ends.

Tear lines of any configuration may be created. They usually have the shape of a U, an open oval, or an open rectangle. It may also be shaped as an alternating line around the above-mentioned basic shapes.

The decisive advantage of the procedure based on the invention is based on the fact that the mold surface determining the surface shape of the outer side may be used as a reference dimension for the positioning of the mold tool. The tolerance of the remaining wall thickness is determined solely by the exact positioning of the mold tool and the tolerances of the mold tool.

The invention is described in more detail by use of embodiment examples.

### DETAILED DESCRIPTION

In a first embodiment example, the shaped piece is manufactured using injection molding. An injection pistol is passed by means of a robot over a mold whose surface has the shape of the negative of the desired shaped piece. The liquid material is sprayed until the desired thickness is achieved. Next, a mold tool with a large number of tips is pressed into the still-plastic material that displaces it. The mold tool may, for example, be a frame shaped like a comb on which a row of tips whose shape, quantity, and arrangement are equal to a negative of the desired tear seam, where the tear seam is formed by a perforation line consisting of a row of blind holes of a specific depth, diameter, and separation with respect to one another. In other words, the entire tear seam may be created by a one-time immersion of the mold tool into the still-plastic material. Thus, the mold tool is pressed into the material up to a defined distance with respect to its surface. If the mold surface is a three-dimensional surface, the frame of this mold surface must be adapted so that all tips assume the same distance from the mold surface when in immersed condition.

Instead of immersing the mold tool to a specific depth, a simpler technical procedure would be to immerse the mold tool until the free ends of the tips strike the mold surface so that it may be withdrawn immediately or after a specified time interval back to a specified depth. Depending on the viscosity of the material, the holes below the free ends of the withdrawn tips may close completely, partially, or not at all.

For a tear seam with blind holes with a constant remaining wall thickness, the tips must have the same length. Very simply, this procedure will also produce tear seams with blind holes of varying depth along the tear seam. Thus, for example, a tear seam adapted to the tear-resistance of various materials may be produced not only by means of varying the impression depths of the entire tip arrangement, but also by providing tips with repetitive variation of length, for example, if each third tip has length a, all the other tips have length b. The tip length may be fixed or adjustable at the mold tool.

In a second embodiment example, the mold tool has fewer tips than the desired tear seam has blind holes. The mold tool is then displaced along the desired tear seam relative to the mold in order to impress a row of blind holes in the material by means of multiple immersions.

The procedure is similar when the shaped piece is produced using a thermal manufacturing process.

Instead of immersing a mold tool into the material that has been completely deposited on the mold surface, the mold tool may also remain in a fixed position awhile during the deposit of material. After the material has hardened, the mold tool is extracted and the shaped piece may be removed from the mold.

Removal of the mold tool during the plastic phase is also conceivable if the material is no longer flowing, i.e., the blind hole shape and depth remain unchanged.

The surface of the mold, determined by the surface features of the mold surface, may either be smooth or textured. With a textured surfaced, the distance between the free ends of the immersed tips and the mold surface may be set very small or next to nothing. Due to the textured surface, the resulting holes in the shaped piece will barely be perceptible. If the mold tool is extracted while the material is in a less fluid condition, resealing the holes with a thinnest layer may be achieved.

In a third embodiment example, the mold tool shall have as a mold element a corrugated cutter shaped blade. The mold surface must be flat in at least the area where the tear seam is to be impressed. The material for the mold is to be completely deposited before the mold tool is lowered to the point where the distance from the surface of the mold is the same as the desired remaining wall thickness. After the material has hardened, the mold tool is again removed, and a corrugated slit remains. The remaining wall thickness may thereby be selected to be thinner than one with a straight slit, which in the long term would become visible from the outside sooner.

1. Procedure to impress a tear seam into thin sheets and thin shaped pieces that were manufactured using a thermal shaping procedure, in which the surface shape is firmly applied to at least one side of the thin film or thinly shaped piece (hereafter called the outer side) by application onto the surface of a mold, and that the material is in a plastic state for a certain time, wherein the tear seam is formed in the material by a mold tool with at least one shaping element during the plastic phase, wherein the mold tool is positioned to a defined distance from the mold surface, and is removed again before the material hardens.

2. Procedure as in claim 1, characterized in that the mold tool with its shaping elements is first moved to a position on the mold surface and is then withdrawn by a defined distance.

3. Procedure as in claim 1, characterized in that the entire tear seam is produced at one time by material displacement by a one-time immersion of the mold tool into the material.

4. Procedure as in claim 1, characterized in that the entire tear seam is produced at one time in that the mold tool is pre-positioned at a distance from the molded surface before the material is deposited on it, and in that the material surrounds the shaping elements of the mold.

5. Procedure as in claim 1, characterized in that the tear seam is produced by multiple lowerings and raisings of the mold tool to the surface of the mold in that the mold tool is displaced along the desired tear seam while it is not engaged with the material.

6. Procedure as in claim 2, characterized in that the entire tear seam is produced at one time by material displacement by a one-time immersion of the mold tool into the material.

7. Procedure as in claim 2, characterized in that the entire tear seam is produced at one time in that the mold tool is pre-positioned at a distance from the molded surface before the material is deposited on it, and in that the material surrounds the shaping elements of the mold.

8. Procedure as in claim 2, characterized in that the tear seam is produced by multiple lowerings and raisings of the mold tool to the surface of the mold in that the mold tool is displaced along the desired tear seam while it is not engaged with the material.
